(19) United States
(12) Patent Application Publication
(10) Pub. No.: US 2015/0138754 A1
(43) Pub. Date: May 21, 2015

(54) HYDROSTATIC AND SPOTLIGHTING WATER FLOW GENERATOR

(71) Applicant: AGREAT SHOWER & SANITARY (XIAMEN) CO., LTD., Xiamen City (CN)

(72) Inventor: PI-KUANG TSAI, Taichung City (TW)

(21) Appl. No.: 14/549,534

(22) Filed: Nov. 20, 2014

(30) Foreign Application Priority Data
Nov. 21, 2013 (TW) 102221823

(51) Int. Cl. F21S 10/00; F03B 13/00

(52) U.S. Cl. CPC F21S 10/002; F03B 13/00; F21W 2121/02
USPC 362/96

(57) ABSTRACT

A hydrostatic and spotlighting water flow generator comprising an outer cashing, a luminous module and a base depends on water flow introduced into a stepped jet stream trough and drives a vane wheel to spin and transfer kinetic energy to electricity and activate an illuminating part for radiation; moreover, water flow through the underneath structure of the hydrostatic and spotlighting water flow generator and fine meshes on the first filter mesh is compulsively decelerated to permeate into coarse meshes on the base and run out as a straight water column for soft tranquil effect. As such, a light source of the illuminating part projects light rays along a straight water column and induces a reflective light source at the water column's end for soft, tranquil and aesthetic spotlighting effect.

### BACKGROUND OF THE INVENTION

1. Field of the Invention

The present disclosure relates to a water flow generator, particularly a hydrostatic and spotlighting water flow generator.

2. Description of the Prior Art

As shown in Taiwan Patent Application No. 100212467, 102201428 and 100206033, China Patent No. 203067162, and U.S. Patent No. 2009026768 and 2009146431, conventional faucet-based generators have some drawbacks as follows: water flow from an ordinary faucet runs into a faucet-based generator via a water inlet as shown in the cited references and runs out through a stream flow space and a water outlet wherein a flow channel between the water inlet and the stream flow space as well as the water outlet's pinhole are not particularly designed in size. As such, spray and noise induced at the water outlet directly by water flow, which is unchangeably supplied to a faucet-based generator from a faucet, is unacceptable in tranquil environment.

As mentioned above, a conventional faucet-based generator with drawbacks is an unideal design and needs to be changed.

### SUMMARY OF THE INVENTION

The present disclosure is to provide a hydrostatic and spotlighting water flow generator which depends on water flow introduced into a stepped jet stream trough and driving a vane wheel to spin, transfers kinetic energy to electricity, and activates an illuminating part for illumination.

The present disclosure is also to provide a hydrostatic and spotlighting water flow generator which compulsively decelerates water flow out of fine meshes on a first filter mesh to permeate into coarse meshes on a base and run out as a straight water column for soft tranquil effect.

The present disclosure is also to provide a hydrostatic and spotlighting water flow generator in which a light source of an illuminating part projects light rays along a straight water column and induces a reflective light source at the water column's end for spotlighting effect.

A hydrostatic and spotlighting water flow generator for above purposes comprises:

an outer cashing with a pilot hole around an interior circumference;

a luminous module held in the outer cashing and comprising: a stepped jet stream trough at the top; a vane wheel installed underneath the stepped jet stream trough and electrically connected to a coil module which generates electricity driving an illuminating part to radiate when the vane wheel spins under effect of swirling flow induced by the stepped jet stream trough; a stream flow space, a sideway space and a flow resistance space linking the stepped jet stream trough and located at top, middle and bottom external sides of the luminous module, respectively; a plurality of convexes equally or unequally distributed around an exterior circumference of the luminous module;

a base circumferentially linking fasteners, which are securely coupled with the pilot hole on the outer cashing and resisted by the convexes, and comprising several coarse meshes at an undersurface;

a first filter mesh covered on the undersurface of the base for development of a flow turbulence space underneath the luminous module and comprising several fine meshes through which water flow permeates.

### BRIEF DESCRIPTION OF THE DRAWINGS

The drawings disclose an illustrative embodiment of the present invention which serves to exemplify the various advantages and objects hereof, and are as follows:

FIG. 1 is an exploded perspective view illustrating a water flow generator in the first embodiment;

FIG. 2 is a schematic view illustrating a water flow generator assembled in the first embodiment;

FIG. 3 is a sectional view illustrating a water flow generator in the first embodiment;

FIG. 4 is a schematic view illustrating a reflective light source induced at the end of a water column;

FIG. 5 is a partial schematic view illustrating a water flow generator assembled in the first embodiment

FIG. 6 is a schematic view illustrating a stepped jet stream trough of a water flow generator in the second embodiment;

FIGS. 7 and 8 are partial sectional views illustrating a stepped jet stream trough of a water flow generator in the second embodiment; and

FIG. 9 is a sectional view illustrating a water flow generator in the second embodiment.

### DETAILED DESCRIPTION OF THE PREFERRED EMBODIMENT

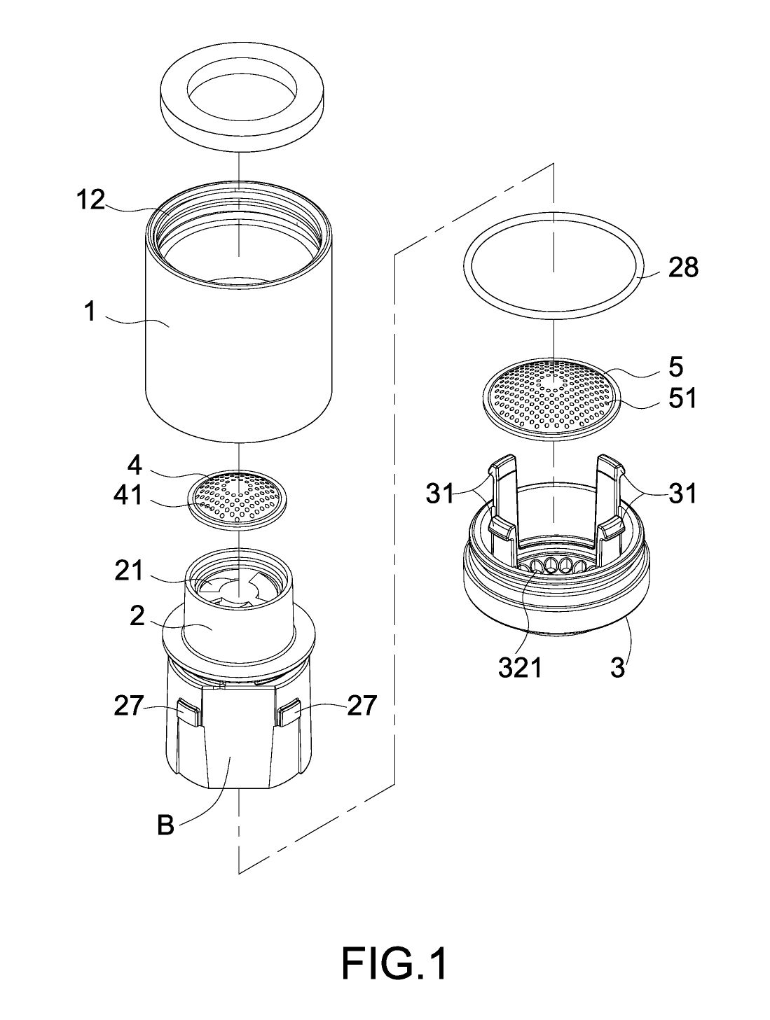

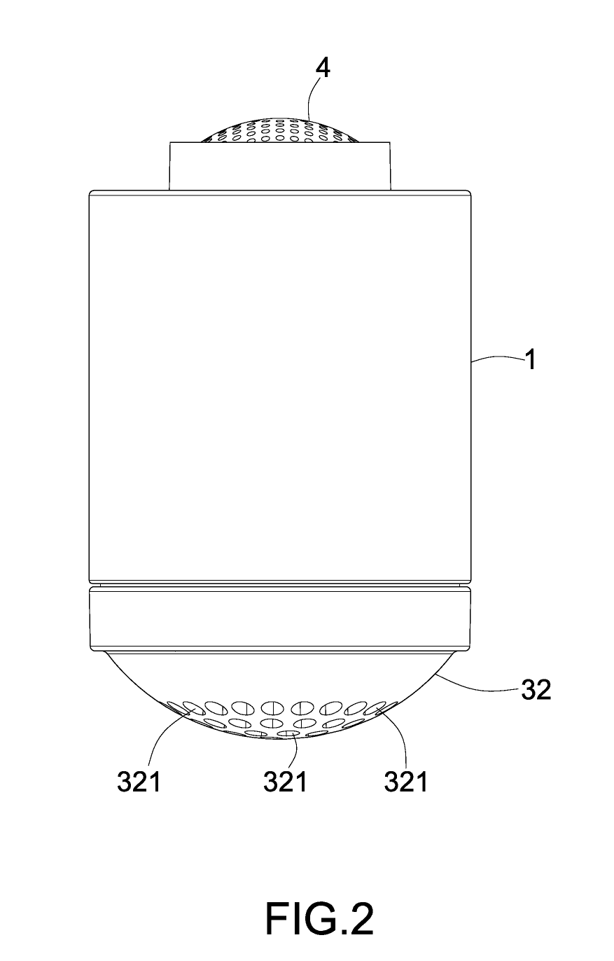

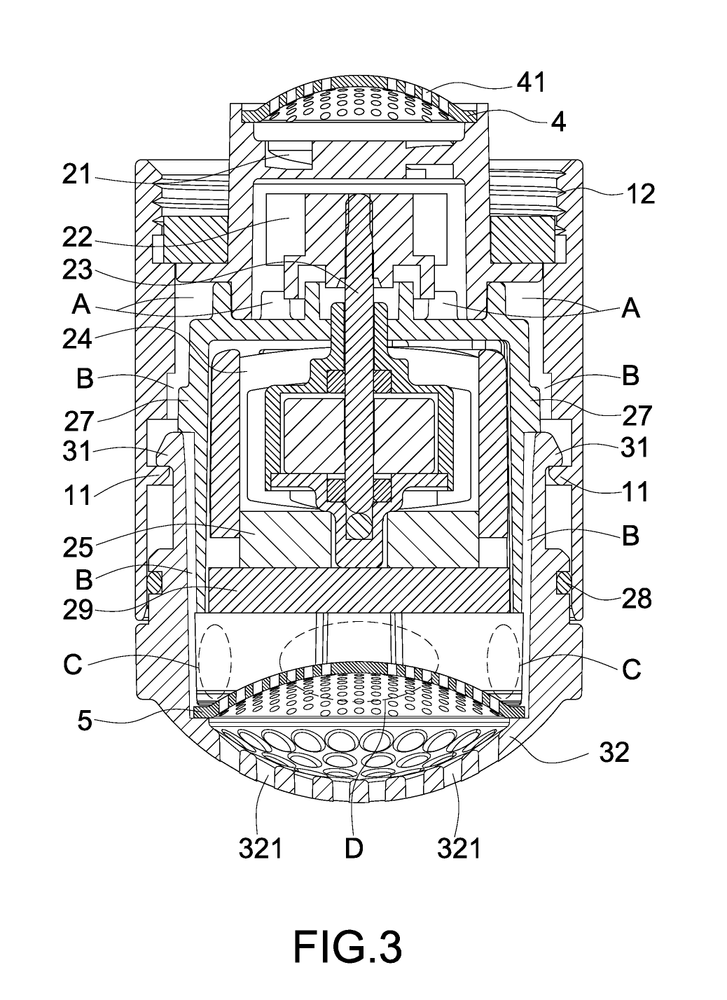

Referring to FIG. 1 through FIG. 3 which illustrates a hydrostatic and spotlighting water flow generator comprises an outer cashing 1, a luminous module 2, a base 3, a first filter mesh 5 and a second filter mesh 4:

the outer cashing 1 comprises a pilot hole 11 around an interior circumference;

the luminous module 2 held in the outer cashing 1 comprises: a stepped jet stream trough 21 at the top; a vane wheel 22 installed underneath the stepped jet stream trough 21 and electrically connected to a coil module 24 which generates electricity driving an illuminating part 25 to radiate when the vane wheel 22 spins under effect of swirling flow induced by the stepped jet stream trough 21; a stream flow space A, a sideway space B and a flow resistance space C linking the stepped jet stream trough 21 and located at top, middle and bottom external sides of the luminous module 2, respectively; a plurality of convexes 27 equally or unequally distributed around an exterior circumference of the luminous module 2 (FIG. 1);

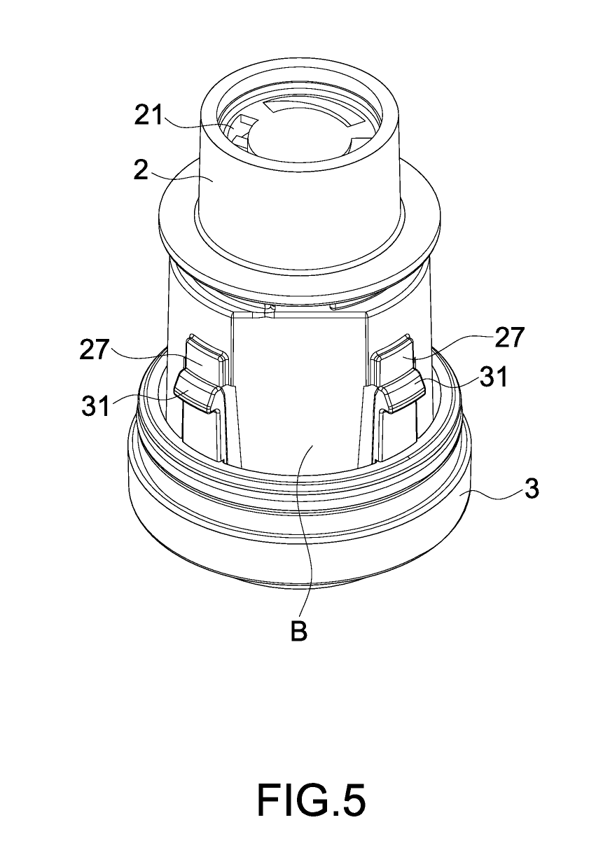

the base 3 circumferentially links fasteners 31, which are securely coupled with the pilot hole 11 on the outer cashing 1 and resisted by the convexes 27 (FIG. 5), comprises several coarse meshes 321 at an undersurface 32, and prevents leakage because of a washer 28 embedded between the base 3 and the outer cashing 1 for watertight effect;

the first filter mesh 5 is covered on the undersurface 32 of the base 3 for development of a flow turbulence space D underneath the luminous module 2 and comprises several fine meshes 51 through which water flow permeates.

the second filter mesh 4 is covered on the top of the luminous module 2 and comprises several pinholes 41 used to screen foreign matters in water flow from a faucet.

As mentioned above, a hydrostatic and spotlighting water flow generator in a preferred embodiment for components and assembling status presents features particularly described as follows:

When the outer cashing 1 is able to link a bathroom faucet via a shower hose or another faucet on a kitchen counter via a flexible hose with internal threads 12 inside is an example described in an embodiment of the present disclosure. Alternatively, the outer cashing 1 is able to link a faucet with external threads 13 (not shown in figures). When a faucet is turned on by a user, the luminous module 2 works regularly because of foreign matters in water flow screened by the pinholes 41 on the second filter mesh 4 and not fed into the stepped jet stream trough 21. The coil module 24 comprises a revolving shaft 23 linking the vane wheel 22, which is driven to spin by water flow introduced into the stepped jet stream trough 21 for generation of electricity from the coil module 24 under effect of the revolving shaft 23 and further radiation from the illuminating part 25. The illuminating part 25 is provided with a transparent dead plate 29 underneath for securing and protecting the coil module 24.

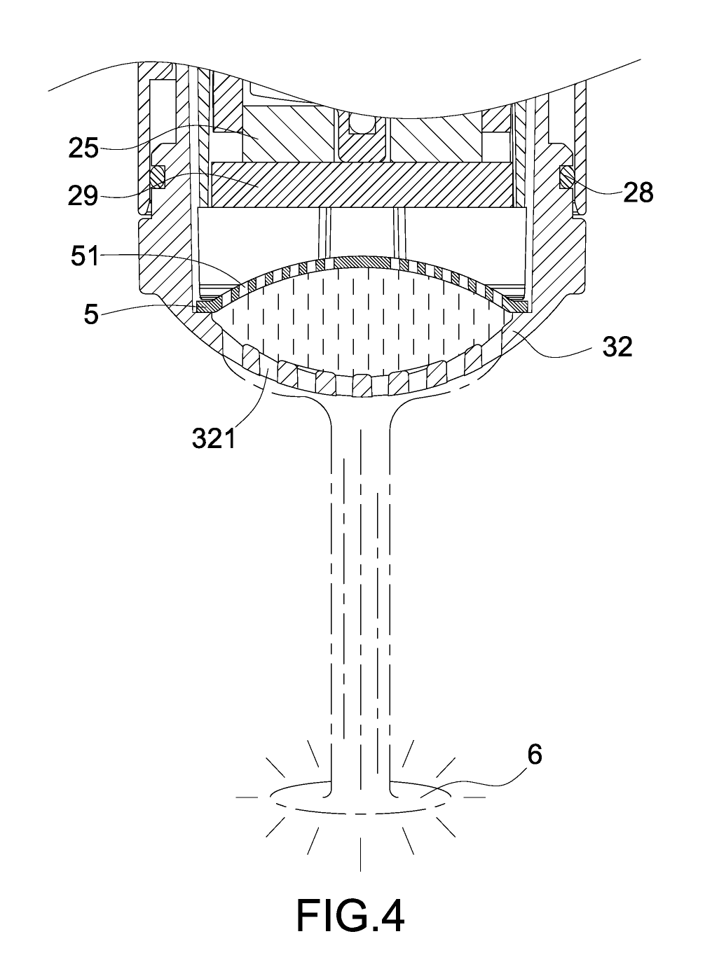

Referring to FIG. 4, a hydrostatic and spotlighting water flow generator features running water which contributes to generation of both electricity and light and cleans objects for sufficient illumination from a light source.

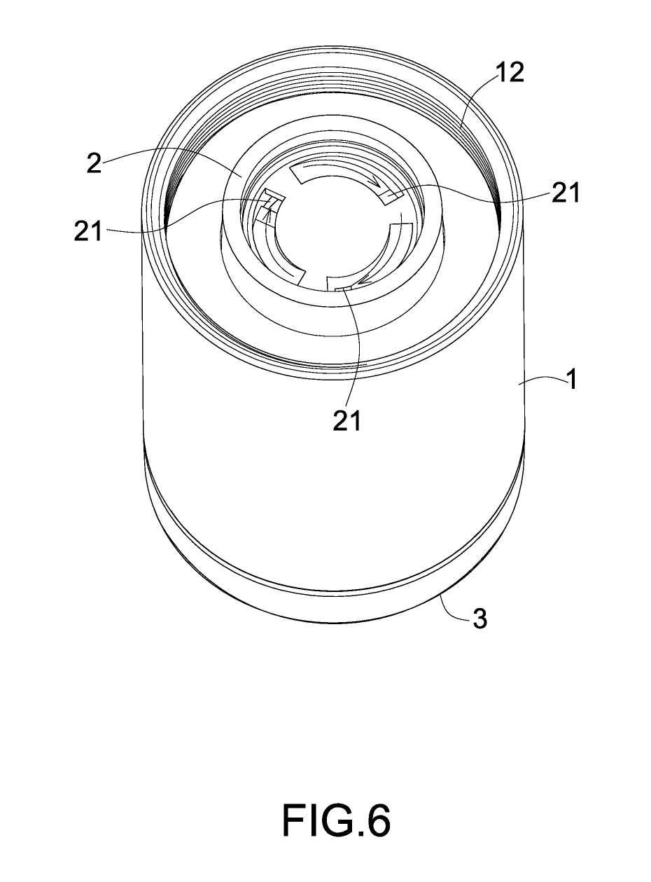

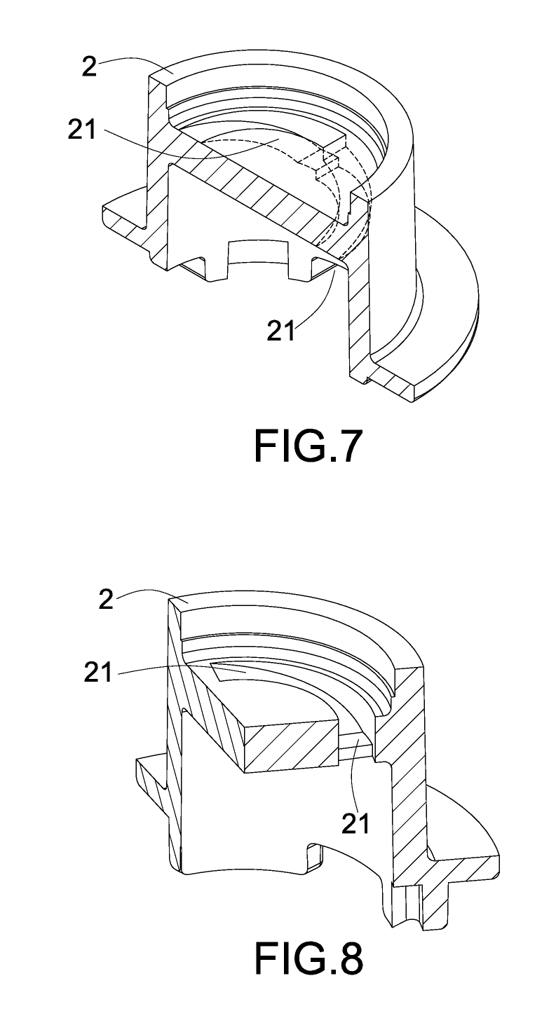

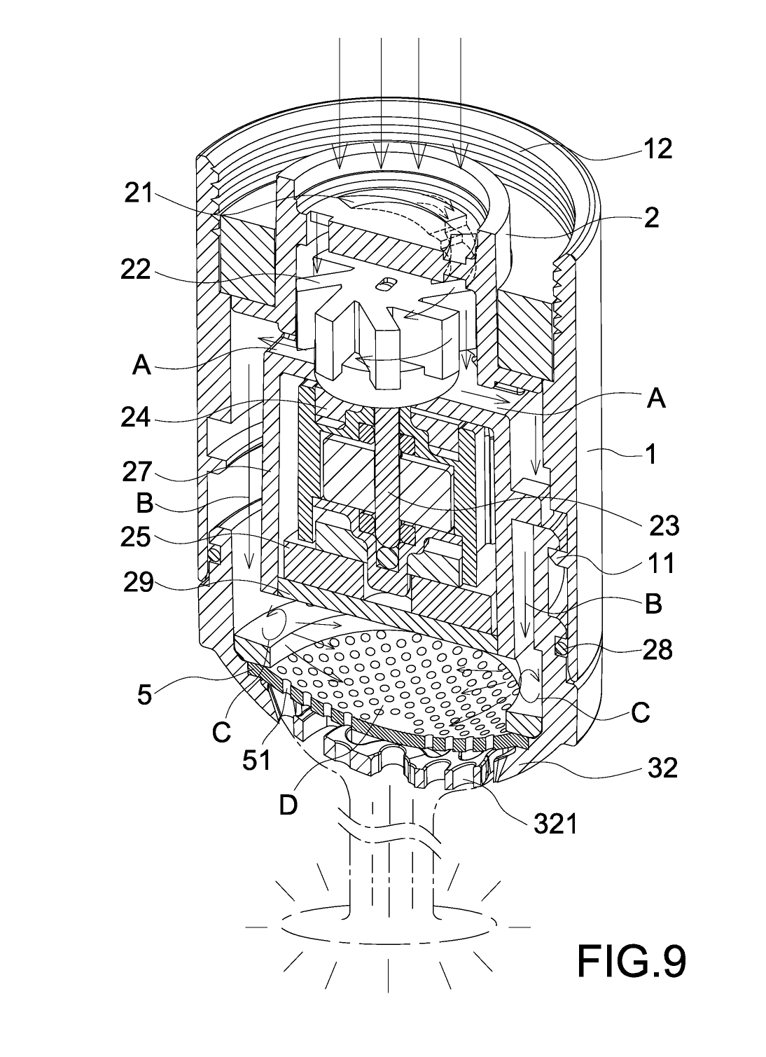

Referring to FIG. 5 through FIG. 8, swirling flow induced by the stepped jet stream trough 21 drives the vane wheel 22 to spin, runs out from the stream flow space A on an exterior surface of the luminous module 2 (FIG. 9), and runs into the sideway space B, the flow resistance space C, and the flow turbulence space D developed under the first filter meshes 5 and the luminous module 2. In general, the swirling flow from the stream flow space A to the sideway space B evolves into high velocity fluid flow which induces quite a little impulsive force or energy applied on the sideway space B and neutralized in the flow resistance space C under the luminous module 2 for reduced flow speed; the swirling flow is further stabilized in the flow turbulence space D underneath the first filter meshes 5 and the luminous module 2 wherein the first filter mesh 5 has a concave surface with several fine meshes 51 which are modest in diameter and compulsively decelerate water flow to permeate into a plurality of coarse meshes 321. Moreover, each of the coarse meshes 321 is greater than each of the fines meshes 51 in thickness of a water outlet. As such, water flow running into the stream flow space A will be changed to a straight water column running out from the coarse meshes 321 due to a difference in thickness of a water outlet.

Furthermore, a light source of the illuminating part 25 which depends on the straight water column as media for light transmission projects light rays and induces a reflective light source 6 at the end of the water column (e.g., a washbasin's surface) and further spotlighting effect; the light source distinct from another light source of a conventional luminous miniature water flow generator is categorized as a diffusive light source which expands applications of a hydrostatic and spotlighting water flow generator in the present disclosure and contributes to market acceptance.

A hydrostatic and spotlighting water flow generator in the present disclosure has the following advantages in contrast to other devices disclosed in cited references or based on conventional arts:

1. The vane wheel 22 driven by water flow transfers kinetic energy to electricity and activates the illuminating part 25 for illumination.

2. The fine meshes 51 on the first filter mesh 5 coordinates the coarse meshes 321 on the base 3 so that water flow runs out as a straight water column for soft tranquil effect.

3. A light source projects light rays along a straight water column as media for light transmission induces the reflective light source 6 at the water column's end and further spotlighting effect.

The above descriptions are examples of a preferred embodiment which do not restrict the scope of a hydrostatic and spotlighting water flow generator; any equivalent change or improvement without departing from spirit of the hydrostatic and spotlighting water flow generator should be incorporated in claims herein.

It can be seen from above descriptions the hydrostatic and spotlighting water flow generator with effects and advantages over conventional water flow generator meets patentability including novelty and non-obviousness.

Many changes and modifications in the above described embodiment of the invention can, of course, be carried out without departing from the scope thereof

Accordingly, to promote the progress in science and the useful arts, the invention is disclosed and is intended to be limited only by the scope of the appended claims.

What is claimed is:

1. A hydrostatic and spotlighting water flow generator, comprising:
an outer cashing with a pilot hole around an interior circumference;
a luminous module held in the outer cashing and comprising: a stepped jet stream trough at the top; a vane wheel installed underneath the stepped jet stream trough and electrically connected to a coil module which generates electricity driving an illuminating part to radiate when the vane wheel spins under effect of swirling flow induced by the stepped jet stream trough; a stream flow space, a sideway space and a flow resistance space linking the stepped jet stream trough and located at top, middle and bottom external sides of the luminous module, respectively; a plurality of convexes equally or unequally distributed around an exterior circumference of the luminous module;
a base circumferentially linking fasteners, which are securely coupled with the pilot hole on the outer cashing and resisted by the convexes, and comprising several coarse meshes at an undersurface;
a first filter mesh covered on the undersurface of the base for development of a flow turbulence space underneath the luminous module and comprising several fine meshes through which water flow permeates.

2. A hydrostatic and spotlighting water flow generator according to claim 1 wherein the fine meshes on the first filter mesh, which are modest in diameter, compulsively decelerate water flow to permeate into the coarse meshes and run out as a straight water column from the coarse meshes.

3. A hydrostatic and spotlighting water flow generator according to claim 1 wherein the illuminating part develops a light source projecting light rays along a straight water column and inducing a reflective light source at the water column's end for spotlighting effect.

4. A hydrostatic and spotlighting water flow generator according to claim 1 wherein the Swirling flow induced by the stepped jet stream trough drives the vane wheel to spin, runs out from the stream flow space A on an exterior surface of the luminous module, and runs into the sideway space, the flow resistance space, and the flow turbulence space developed under the first filter meshes and the luminous module. In general, the swirling flow from the stream flow space to the sideway space evolves into high velocity fluid flow which induces quite a little impulsive force or energy applied on the sideway space and neutralized in the flow resistance space under the luminous module for reduced flow speed; the swirling flow is further stabilized in the flow turbulence space underneath the first filter meshes and the luminous module.
